(19) United States
(12) Patent Application Publication
(10) Pub. No.: US 2006/0269343 A1
(43) Pub. Date: Nov. 30, 2006

(54) CAD system and text input support method

(76) Inventors: Kazuhiko Nagao, Hamura-shi (JP); Masatoshi Owada, Iruma-shi (JP); Tsukasa Soejima, Hamura-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/444,582

(22) Filed: May 31, 2006

(30) Foreign Application Priority Data
May 31, 2005 (JP) 2005-159640

(51) Int. Cl. B41J 5/30

(52) U.S. Cl. 400/62

(57) ABSTRACT

According to one embodiment, a CAD system loads, from an attribute file, attribute information which defines an arbitrary character string as the attribute name, and manages the arbitrary character string defined based on the attribute information, as the first character string in the attribute table. The CAD system edits the second character string which corresponds to the first character string in the attribute table, and lists and displays all of the first character strings stored in the attribute table, as an attribute list. And the CAD system acquires, from the attribute table, the second character string corresponding to the selected first character string of the listed and displayed first character strings, and arranges the acquired second character string in an input target area on a layer which is being designed.

### CROSS-REFERENCE TO RELATED APPLICATIONS

This application is based upon and claims the benefit of priority from Japanese Patent Application No. 2005-159640, filed May 31, 2005, the entire contents of which are incorporated herein by reference.

### BACKGROUND

1. Field

One embodiment of the invention relates to a text input support technique suitable to be applied to a CAD system for a printed circuit board (PCB).

2. Description of the Related Art

In recent years, a semiconductor manufacturing technique has remarkably improved, and there is a trend toward increasing the number of layers and size of a printed circuit board. To cope with such situation, various proposals have been made to efficiently perform the design job of a printed circuit board (for example, see Japanese Patent Application Publication(KOKAI) No. 2002-32415).

In the prior art, in text input, characters must be input for each layer. Hence, for example, even when the identical texts are to be input to a plurality of layers, the input job is performed for each layer.

When the input job is performed for each layer as described above, a typing error probably occurs, and a correction job must be performed for each layer in order to correct the texts. As a result, a correction error tends to occur, and the number of job processes increases, thus posing a problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the device arrangement of a CAD system according to an embodiment of the invention;

FIG. 2 is an exemplary block diagram showing the module arrangement of a CAD program according to the embodiment;

FIG. 3 is a view showing an example of a printed wiring board designed by the CAD system according to the embodiment;

FIG. 4 is a view showing an example of attribute information stored in an attribute file used in the CAD system according to the embodiment;

FIG. 5 is an exemplary view showing an edit window displayed by the CAD system according to the embodiment;

FIG. 6 is the first view for explaining an example of a text input job procedure in the CAD system according to the embodiment (an example of a layer which is being designed);

FIG. 7 is the second view for explaining an example of a text input job procedure in the CAD system according to the embodiment (a display example of a text input window);

FIG. 8 is the third view for explaining an example of a text input job procedure in the CAD system according to the embodiment (a display example of an attribute list window);

FIG. 9 is the fourth view for explaining an example of a text input job procedure in the CAD system according to the embodiment (an example of a layer after text input);

FIG. 10 is the fifth view for explaining an example of a text input job procedure in the CAD system according to the embodiment (an example of a text inserted in CAD data);

FIG. 11 is the sixth view for explaining an example of a text input job procedure in the CAD system according to the embodiment (a display example of an attribute edit window);

FIG. 12 is the seventh view for explaining an example of a text input job procedure in the CAD system according to the embodiment (an example of a text edited and reflected to the CAD data);

FIG. 13 is the eighth view for explaining an example of a text input job procedure in the CAD system according to the embodiment (an example of a layer after attribute edit);

FIG. 14 is an exemplary flowchart showing the first operation sequence of text input in the CAD system according to the embodiment;

FIG. 15 is an exemplary flowchart showing the second operation sequence of text input in the CAD system according to the embodiment; and

FIG. 16 is an exemplary flowchart showing the third operation sequence of text input in the CAD system according to the embodiment.

### DETAILED DESCRIPTION

Various embodiments according to the invention will be described hereinafter with reference to the accompanying drawings. In general, according to one embodiment of the invention, a CAD system for designing a printed circuit board made up of a plurality of stacked layers comprises an attribute table management unit configured to manage an attribute table in which a first character string serving as an attribute name corresponds to a second character string serving as an input text, an attribute file load unit configured to load, from an attribute file, attribute information which defines an arbitrary character string as the attribute name, and to store the arbitrary character string defined based on the attribute information, as the first character string in the attribute table, an attribute edit unit configured to edit the second character string which corresponds to the first character string in the attribute table, an attribute list display unit configured to list and display all of the first character strings stored in the attribute table, as an attribute list, and a text arrangement unit configured to acquire, from the attribute table, the second character string corresponding to the selected first character string of the first character strings listed and displayed by the attribute list display unit, and to arrange the acquired second character string in an input target area on a layer which is being designed.

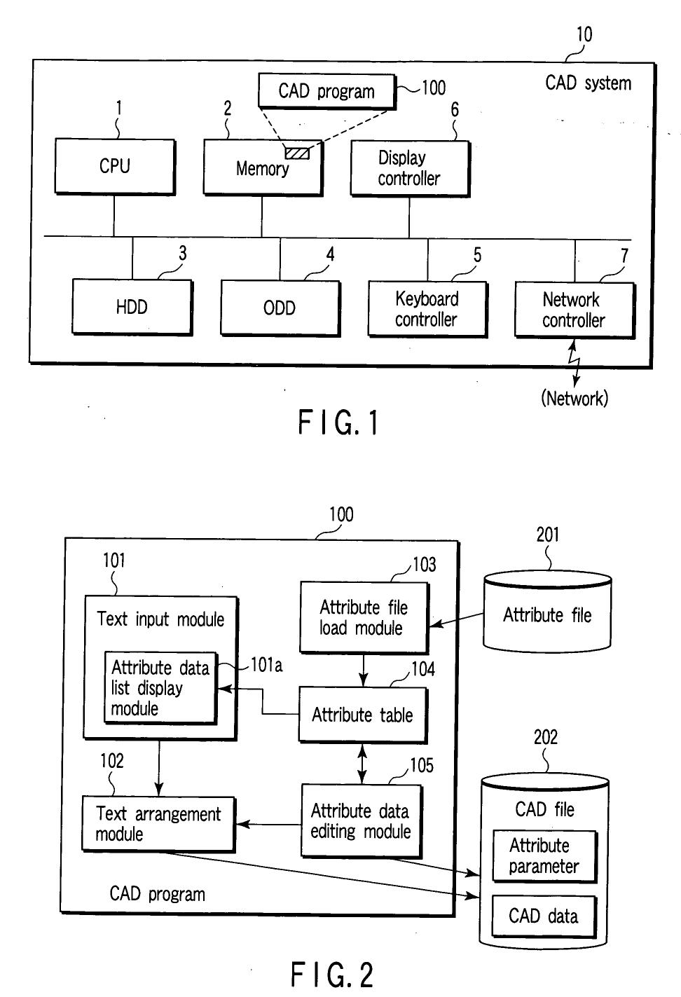

FIG. 1 is an exemplary block diagram showing the device arrangement of a CAD system according to the embodiment of the invention.

A CAD system 10 according to the embodiment is implemented using, e.g., a desktop type or notebook type personal computer, and includes a CPU 1, memory 2, HDD (hard disk drive) 3, ODD (optical disk drive) 4, keyboard controller 5, display controller 6, and network controller.

The CPU 1 controls the overall operation of the computer, and executes various programs stored in the memory 2. The memory 2 is a storage medium serving as the main memory of this computer, and stores various programs and various data used for these programs executed by the CPU 1. Each of the HDD 3 and ODD 4 is a storage medium serving as an external memory of this computer, and stores a large amount of various programs and data, as the auxiliary device of the memory 2.

The keyboard controller 5 controls the input side of a user interface provided in this computer, and inputs operation data with a keyboard, mouse, and the like. The display controller 6 controls the output side of the user interface provided in this computer, and displays the display data of the various programs on an LCD or the like. A network controller 7 executes communication control for transmitting/receiving data via a network such as a LAN (local area network) or the Internet.

A CAD program 100 is a program for causing the personal computer to operate as the CAD system 10 according to the embodiment. The CAD program 100 is loaded from the HDD 3 to the memory 2 to be executed by the CPU 1, allows user operation via the keyboard controller 5, and achieves information presentation for a user via the display controller 6.

FIG. 2 is an exemplary block diagram showing the module arrangement of the CAD program 100. As shown in FIG. 2, the CAD program 100 has a text input module 101, text arrangement module 102, attribute file load module 103, attribute table 104, and attribute data editing module 105.

Upon activation, the CAD program 100 loads an attribute file 201 using the attribute file load module 103. The attribute file 201 stores attribute information which defines a character string serving as an attribute name. Upon loading the attribute information, the attribute file load module 103 stores, in the attribute table 104, the attribute name defined based on the attribute information. The attribute file 201 may be loaded from the HDD 3, or obtained via the network using the network controller 7. The attribute table 104 is a table for associating an arbitrary text with the attribute name loaded from the attribute file 201. The text in the attribute table 104 can be edited (e.g., input, changed, and deleted) by the attribute data editing module 105.

The text input module 101 is used to input an arbitrary text to an arbitrary layer of a printed circuit board in a design job, and has an attribute data list display module 101a. The attribute data list display module 101a is activated upon a predetermined operation in text input, and lists and displays the attribute names stored in the attribute table 104.

When one of the listed and displayed attribute names is selected, the attribute data list display module 101a transfers the selected attribute name and its corresponding text to the text arrangement module 102. The text arrangement module 102 arranges the received information in a corresponding position in CAD data.

That is, in the CAD system according to the embodiment, in the design job of the printed circuit board, a user can input a text to each layer directly or by selecting a preset attribute name.

Upon editing the text corresponding to the attribute name in the attribute table 104, the attribute data editing module 105 notifies the text arrangement module 102 of a message indicating this. Upon reception of this notification, the text arrangement module 102 simultaneously updates all of the texts which have been arranged in correspondence with the attribute name in the CAD system. The CAD data serving as the printed circuit board design data is stored in a CAD file 202, and the attribute data editing module 105 stores the edit target content in the attribute table 104, as an attribute parameter in the CAD file 202. Similar to the attribute file 201, the CAD file 202 may be present in the HDD 3 or a remote place connected via the network.

That is, in the CAD system according to the embodiment, even when the identical texts input to a plurality of layers must be corrected, if the texts are input by selecting a corresponding attribute name, the texts in the plurality of layers can be simultaneously replaced only by editing the text corresponding to the selected attribute name.

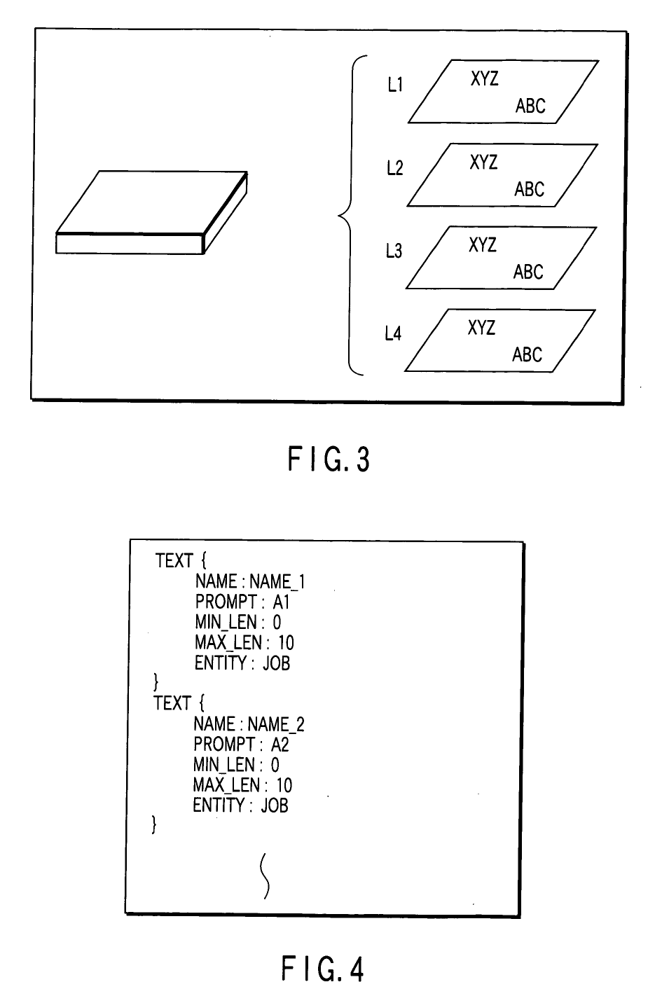

FIG. 3 is a view showing an example of a printed wiring board designed by the CAD system 10 according to the embodiment. The printed wiring board shown in FIG. 3 is made up of stacked four layers L1 to L4. Texts “ABC” and “XYZ” are input for each layer. In this case, conventionally, since the texts “ABC” and “XYZ” are input for each layer, an input error tends to occur. For example, when “ABC” is to be corrected into “DEF”, “ABC” must be corrected for each layer. In contrast to this, in the CAD system according to the embodiment, the concept of “attribute” is adapted to achieve efficient operation.

FIG. 4 is a view showing an example of attribute information stored in the attribute file 201. As shown in FIG. 4, the attribute information includes text data, and one attribute is defined for each description “TEXT{ }”. In this case, attribute names “NAME_1” and “NAME_2” are defined in NAME fields. In PROMPT fields, character strings (“A1” and “A2”) are presented, which are described as identifiers when listing and displaying these attributes in text input.

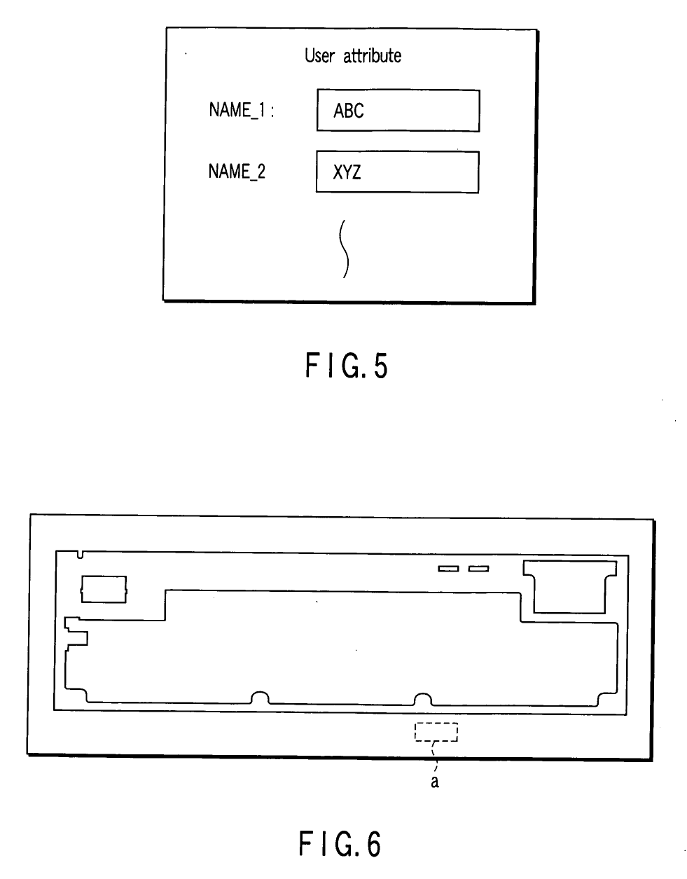

FIG. 5 is a view showing an edit window displayed by the attribute data editing module 105. As shown in FIG. 5, the attribute data editing module 105 presents the edit window which has the input fields for the texts corresponding to the attribute names, and stores, in the attribute table, the texts input to these input fields.

In this case, “ABC” is input to the input field “NAME_1”, and “XYZ” is input to the input field “NAME_2”. Therefore, in the printed wiring board design job shown in FIG. 3, when “ABC” and “XYZ” are to be input to each layer, an input error can be eliminated by allowing selection of the attribute identifiers (A1 and A2) from the list. For example, in order to correct “ABC” into “DEF”, “ABC” can be simultaneously replaced only by performing correction on the edit window shown in FIG. 5.

The examples of the text input job procedures in the CAD system according to the embodiment will be described with reference to FIGS. 6 to 13.

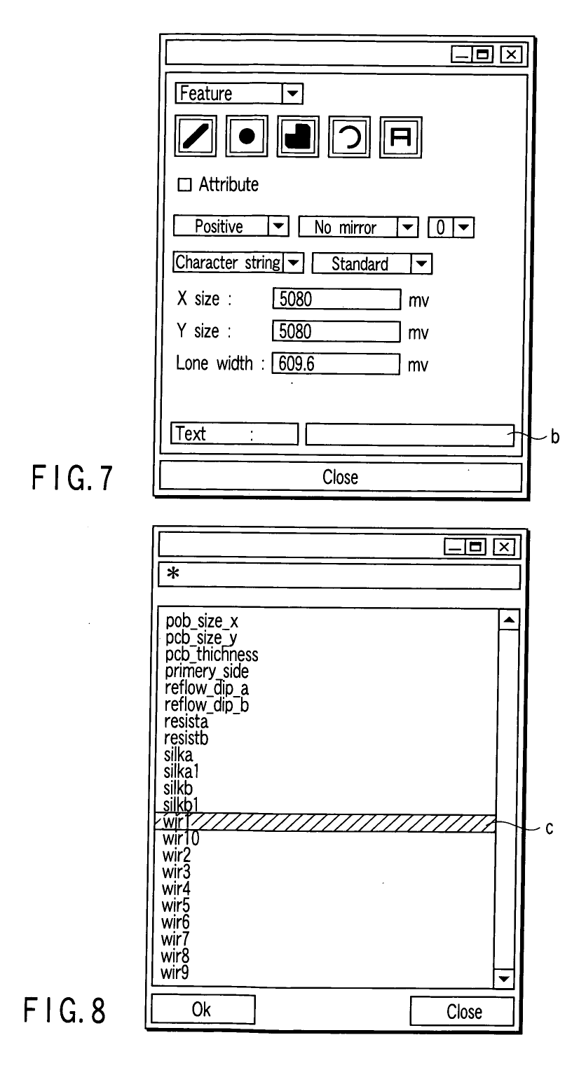

Assume that a wiring pattern shown in FIG. 6 is being designed on a given layer, and a repetitive text to be also used in another layer is to be input to an area a. In such case, the user presses a predetermined key on the keyboard to display a text input window as shown in FIG. 7.

On this text input window, the user can directly input the text to a field b. For example, the user can also press a predetermined key on the keyboard to display an attribute list window shown in FIG. 8, and select one of attributes on this window to input the text corresponding to the selected attribute.

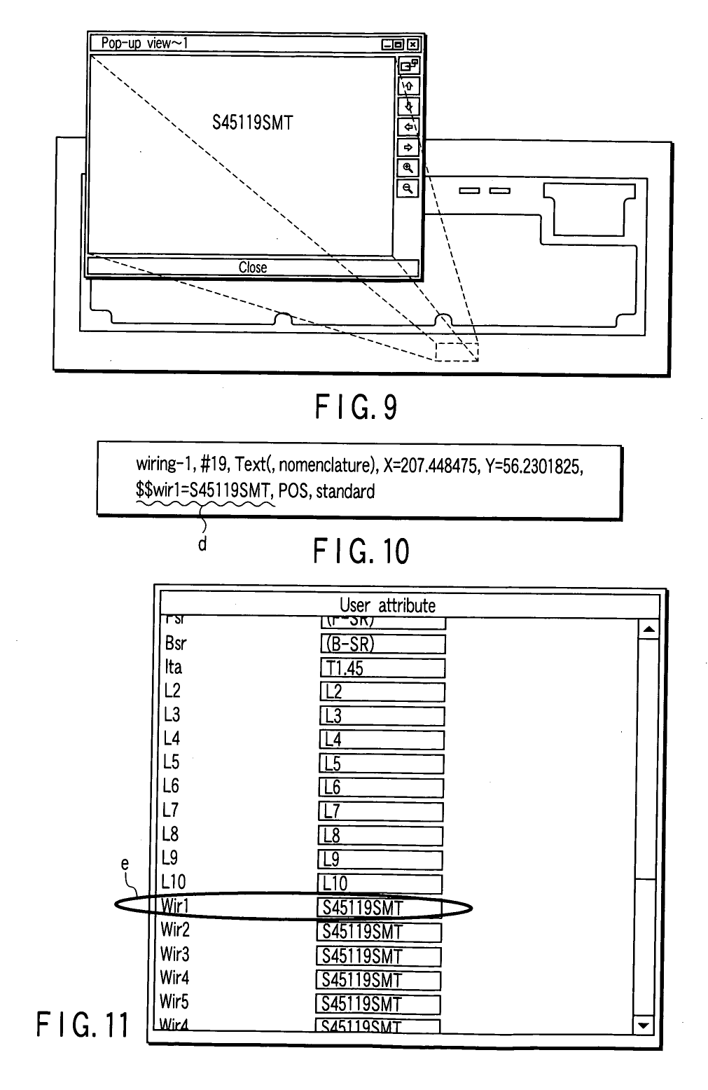

In this case, the attribute list window shown in FIG. 8 is displayed, and an identifier c, i.e., “wirl” is selected on this window. Assume that “wirl” is a character string described in the PROMPT field of given attribute information, and in the attribute table 104, a character string described as an attribute name in the NAME field of “TEXT{ }” corresponds to a character string “S45119SMT”. Accordingly, as shown in FIG. 9, the text “S45119SMT” is input upon selecting the attribute presented by the identifier “wirl”. This input text is inserted into CAD data in a format as shown in FIG. 10. As shown in FIG. 10, information representing the combination between the attribute identifier and the text corresponding to this attribute in the attribute table 104 is stored (d).

When the input text “S45119SMT” is to be corrected to a text “12345”, the user presses a predetermined key on the keyboard to display an attribute edit window shown in FIG. 11. Assume that “twirl” is described the NAME field of the attribute whose “wirl” is described in the PROMPT field. The user then corrects “S45119SMT” described in an input field (e) of “wirl” on the attribute edit window, into “12345”.

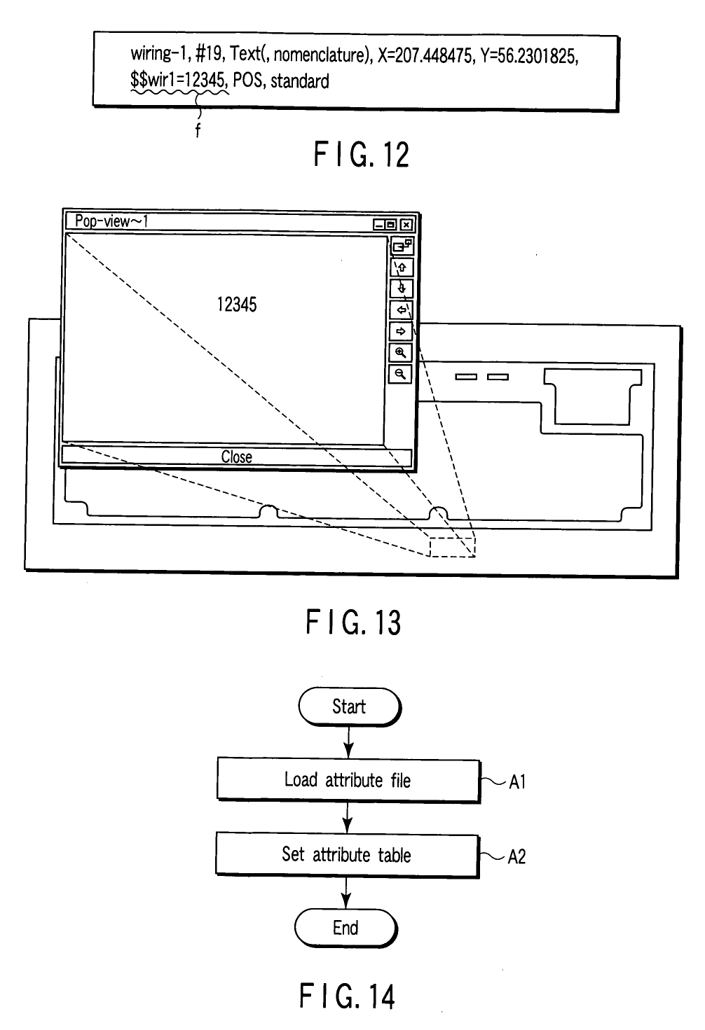

Upon execution of this job, as shown in FIG. 12, this correction is reflected to the text of information inserted into the CAD data (f). As a result, as shown in FIG. 13, the texts arranged on the respective layers are also replaced and displayed. If the same attribute is arranged on another layer, a text of this attribute on the layer is also simultaneously replaced.

FIGS. 14 to 16 are exemplary flowcharts showing the operation sequence of text input in the CAD system 10 according to the embodiment.

Upon activation, the CAD system 10 first loads the attribute file 201 (block A1 in FIG. 14), and sets the loaded file to the attribute table 104 (block A2 in FIG. 14).

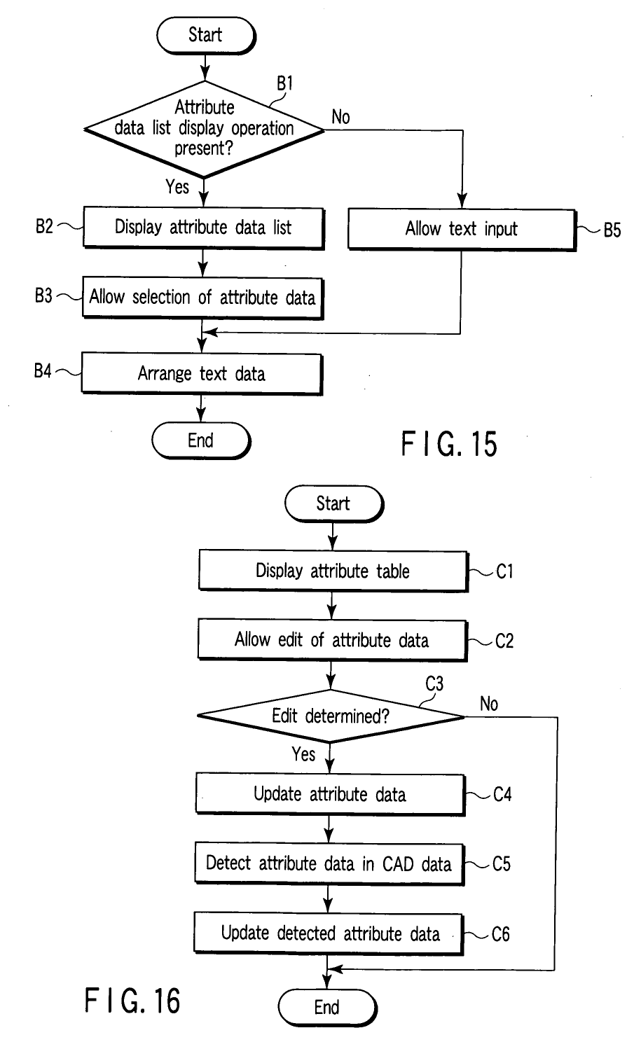

Upon performing attribute data list display operation in text input (YES in block B1 in FIG. 15), the CAD system 10 lists and displays the attribute data stored in the attribute table 104 (block B2 in FIG. 15) to allow selection of a given identifier (block B3 in FIG. 15). The CAD system 10 then arranges a text corresponding to the selected identifier in the CAD data (block B4 in FIG. 15).

On the other hand, when the attribute data list display operation is not executed (NO in block B1 in FIG. 15), the CAD system 10 allows direct text input (block B5 in FIG. 15), and arranges the input text in the CAD data (block B4 in FIG. 15).

When the attribute is to be edited, the CAD system 10 first displays the attribute table 104 (block C1 in FIG. 16), and allows edit of the attribute data (block C2 in FIG. 16). Upon execution of this edit determination operation (YES in block C3 in FIG. 16), the CAD system 10 updates the attribute table 104 (block C4 in FIG. 16), detects the attribute data from the CAD data (block C5 in FIG. 16), and updates the detected attribute data (block C6 in FIG. 16).

As described above, in the CAD system 10 according to the embodiment, the number of human errors such as an input error and correction error can be reduced by embodying the concept of attribute, thus performing efficient text input.

Note that in the above described embodiment, a text is input in accordance with an attribute. However, the present invention is not limited to this. The present invention can also be applied to a technique implemented by using a pattern, pad, comment, or the like in CAD data for a printed wiring board.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A CAD system for designing a printed circuit board made up of a plurality of stacked layers, comprising:
an attribute table management unit configured to manage an attribute table in which a first character string serving as an attribute name corresponds to a second character string serving as an input text;
an attribute file load unit configured to load, from an attribute file, attribute information which defines an arbitrary character string as the attribute name, and to store the arbitrary character string defined based on the attribute information, as the first character string in the attribute table;
an attribute edit unit configured to edit the second character string which corresponds to the first character string in the attribute table;
an attribute list display unit configured to list and display all of the first character strings stored in the attribute table, as an attribute list; and
a text arrangement unit configured to acquire, from the attribute table, the second character string corresponding to the selected first character string of the first character strings listed and displayed by the attribute list display unit, and to arrange the acquired second character string in an input target area on a layer which is being designed.

2. The CAD system according to claim 1, wherein the text arrangement unit simultaneously replaces, when the second character string which corresponds to the first character string in the attribute table is edited by the attribute edit unit, all of the arranged and unedited second character strings into edited second character strings.

3. The CAD system according to claim 2, wherein the attribute edit unit adds, to CAD data, a relationship between the first character string and the second character string in the attribute table, as accessory information.

4. A program for causing a computer to operate as a CAD system for designing a printed circuit board made up of a plurality of stacked layers, wherein the computer functions as
an attribute table management unit configured to manage an attribute table in which a first character string serving as an attribute name corresponds to a second character string serving as an input text,
an attribute file load unit configured to load, from an attribute file, attribute information which defines an arbitrary character string as the attribute name, and to store the arbitrary character string defined based on the attribute information, as the first character string in the attribute table;
an attribute edit unit configured to edit the second character string which corresponds to the first character string in the attribute table;
an attribute list display unit configured to list and display all of the first character strings stored in the attribute table, as an attribute list; and
a text arrangement unit configured to acquiring, from the attribute table, the second character string corresponding to the selected first character string of the first character strings listed and displayed by the attribute list display unit, and to arrange the acquired second character string in an input target area on a layer which is being designed.

5. The program according to claim 4, wherein the text arrangement unit simultaneously replaces, when the second character string which corresponds to the first character string in the attribute table is edited by the attribute edit unit, all of the arranged and unedited second character strings into edited second character strings.

6. The program according to claim 4, wherein the attribute edit unit adds, to CAD data, a relationship between the first character string and the second character string in the attribute table, as accessory information.

7. A text input support method applied to a CAD system for designing a printed circuit board made up of a plurality of stacked layers, comprising:
loading, from an attribute file, attribute information which defines an arbitrary character string as the attribute name, and managing the arbitrary character string defined based on the attribute information, as the first character string in the attribute table;
editing the second character string which corresponds to the first character string in the attribute table;
listing and displaying all of the first character strings stored in the attribute table, as an attribute list; and
acquiring, from the attribute table, the second character string corresponding to the selected first character string of the listed and displayed first character strings, and arranging the acquired second character string in an input target area on a layer which is being designed.

8. The text input support method according to claim 7, further comprising simultaneously replacing, when the second character string which corresponds to the first character string in the attribute table is edited, all of the arranged and unedited second character strings into edited second character strings.

9. The text input support method according to claim 7, further comprising adding, to CAD data, a relationship between the first character string and the second character string in the attribute table, as accessory information.
